(19) United States
(12) Patent Application Publication
(10) Pub. No.: US 2025/0320758 A1
(43) Pub. Date: Oct. 16, 2025

(54) UNIVERSAL LOCKING APPARATUS, SYSTEM, AND METHODS OF USE

(71) Applicant: Tyco Fire & Security GMBH, Neuhausen am Rheinfall (CH)

(72) Inventors: Brian SEARFOSS, Mount Pleasant, SC (US); Steven James MALONE, Mount Pleasant, SC (US)

(21) Appl. No.: 19/175,845

(22) Filed: Apr. 10, 2025

Related U.S. Application Data
(60) Provisional application No. 63/632,368, filed on Apr. 10, 2024.

(51) Int. Cl. E05C 19/00; E05B 63/00; E05C 19/08

(52) U.S. Cl. CPC E05C 19/003; E05B 63/0052; E05C 19/08

(57) ABSTRACT

A door latch device may include a first mounting bracket for mounting to a first door or gate. The device may further include a second mounting bracket for mounting to a second door or gate, and a locking bar with a hasp and a hasp opening configured to be slideably received by a locking bar retainer of the first mounting bracket and a second locking bar retainer of the second mounting bracket, wherein the locking bar is configured to be slid through the locking bar retainer and into the second locking bar retainer until a hasp of the locking bar passes through a lock mount opening of a lock mounting portion of the first mounting bracket, and wherein the hasp opening is configured to have a lock bolt passed therethrough to lock the position of the locking bar with respect to the first mounting bracket.

### CROSS-REFERENCE TO RELATED APPLICATION

This application claims priority to U.S. Provisional Application No. 63/632,368, Titled: UNIVERSAL LOCKING APPARATUS, SYSTEM, AND METHODS OF USE, and filed on Feb. 10, 2024, the entirety of which is incorporated by reference herein.

### FIELD

The present disclosure relates to a locking apparatus, and more particularly to a locking apparatus that can be used to secure various types of enclosures.

### BACKGROUND

Enclosures such as vehicles, cabinets, shelters, containers, gates, garages, doors, and other enclosures are typically secured with locking systems such as a conventional padlock that is mounted onto a hasp assembly to secure access to the enclosed area. One example of one such lock is known as a “puck lock.” A puck lock is typically mounted on a hasp assembly and may be more secure than a typical padlock because the bolt of the puck lock is a hidden shackle bolt that is less accessible than a bolt of a typical padlock. The hidden shackle bolt of the puck lock projects and retracts through the hasp to secure the puck lock onto the hasp when a user retracts the bolt by turning a mechanical key to lock and unlock the lock. While puck locks offer a high level of security, in practice there are challenges with adapting puck locks to secure various different types of enclosures. Thus, there is an industry need for an improved locking apparatus.

### SUMMARY

The following presents a simplified summary of one or more aspects of the invention in order to provide a basic understanding of such aspects. This summary is not an extensive overview of all contemplated aspects and is intended to neither identify key or critical elements of all aspects nor delineate the scope of any or all aspects. Its purpose is to present some concepts of one or more aspects in a simplified form as a prelude to the more detailed description that is presented later.

Aspects of the disclosure relate to a lock system, including: a first mounting bracket for mounting to a first door or gate and a second mounting bracket for mounting to a second door or gate. The system further includes a locking bar with a hasp and a hasp opening configured to be slideably received by a locking bar retainer of the first mounting bracket and a second locking bar retainer of the second mounting bracket. The locking bar is configured to be slid through the locking bar retainer and into the second locking bar retainer until a hasp of the locking bar passes through a lock mount opening of a lock mounting portion of the first mounting bracket, and wherein the hasp opening is configured to have a lock bolt passed therethrough to lock the position of the locking bar with respect to the first mounting bracket.

In some aspects, the techniques described herein relate to a lock system, wherein the hasp is configured to be guided into the lock mount opening via an angled hasp guide portion.

In some aspects, the techniques described herein relate to a lock system, wherein a lock is configured to be mounted to the lock mounting portion of the first mounting bracket.

In some aspects, the techniques described herein relate to a lock system, wherein the lock mounting portion is configured to have the lock mounted thereto via one or more threaded fasteners passed through openings in the lock mounting portion.

In some aspects, the techniques described herein relate to a lock system further including a slide stop mechanism, wherein the slide stop mechanism prevents the locking bar from being slid out of the second locking bar retainer of the second mounting bracket.

In some aspects, the techniques described herein relate to a lock system, further including a plurality of clamp brackets for mounting at least one of the first mounting bracket or the second mounting bracket to a tube.

In some aspects, the techniques described herein relate to a lock system, wherein the lock mounting portion further includes a curved lock guard for covering at least a portion of a lock mounted to the lock mounting portion.

In some aspects, the techniques described herein relate to a door latch usable with a lock, including: a first mounting bracket for mounting to a first door or gate; a second mounting bracket for mounting to a second door or gate; a locking bar with a hasp and a hasp opening configured to be slideably received by a locking bar retainer of the first mounting bracket and a second locking bar retainer of the second mounting bracket, wherein the locking bar is configured to be slid through the locking bar retainer and into the second locking bar retainer until a hasp of the locking bar passes through a lock mount opening of a lock mounting portion of the first mounting bracket, and wherein the hasp opening is configured to have a lock bolt passed therethrough to lock the position of the locking bar with respect to the first mounting bracket and wherein a lock is configured to be mounted to the lock mounting portion of the first mounting bracket.

In some aspects, the techniques described herein relate to a door latch, wherein the hasp is configured to be guided into the lock mount opening via an angled hasp guide portion.

In some aspects, the techniques described herein relate to a door latch, wherein the lock mounting portion is configured to have the lock mounted thereto via one or more threaded fasteners passed through openings in the lock mounting portion.

In some aspects, the techniques described herein relate to a door latch, further including a slide stop mechanism, wherein the slide stop mechanism prevents the locking bar from being slid out of the second locking bar retainer of the second mounting bracket.

In some aspects, the techniques described herein relate to a door latch, further including a plurality of clamp brackets for mounting at least one of the first mounting bracket or the second mounting bracket to a tube.

In some aspects, the techniques described herein relate to a door latch, wherein the lock mounting portion further includes a curved lock guard for covering at least a portion of a lock mounted to the lock mounting portion.

It will be understood that other aspects of combined components and methods for producing components will become readily apparent to those skilled in the art from the following detailed description, wherein it is shown and described in the detailed examples by way of illustration. As will be realized by those skilled in the art, the disclosed subject matter may be varied or modified, all without departing from the present disclosure. Accordingly, the drawings and detailed description are to be regarded as illustrative in nature and not as restrictive.

### BRIEF DESCRIPTION OF THE DRAWINGS

FIG. 1 is a front perspective view of a locking system according to aspects of the disclosure mounted on a first type of enclosure.

FIG. 2 is a front perspective view of a locking system according to aspects of the disclosure mounted on a second type of enclosure.

FIG. 3 is a front perspective component view of a locking system according to aspects of the disclosure.

FIG. 4A is a front perspective view of a locking system according to aspects of the disclosure.

FIG. 4B is a downward partial perspective view of a locking system according to aspects of the disclosure.

FIG. 5A is a partially see-through front perspective view of a locking system according to aspects of the disclosure.

FIG. 5B is a partial right-side perspective view of a locking system according to aspects of the disclosure.

FIG. 6A shows a perspective view of an example lock usable with the locking system described herein in a locked configuration.

FIG. 6B shows a perspective view the lock of FIG. 6A in an unlocked configuration.

FIGS. 7A and 7B are side views showing examples of misalignment features of the locking system according to aspects of the disclosure.

FIG. 7C shows an example top-down view of a portion of locking system to show additional examples of misalignment features of the locking system.

FIG. 8A shows a side view of a locking system according to aspects of the disclosure.

FIGS. 8B and 8C show a side view and partial views about section A-A in FIG. 8A of a locking system to show additional examples of misalignment features according to aspects of the disclosure.

### DETAILED DESCRIPTION

The present disclosure provides a locking apparatus and system, along with corresponding methods, which provide an adaptable and affordable security solution that allows the use of puck locks to secure various types of enclosures. Further, aspects of the present disclosure provide an adaptable locking system that can be installed to secure various different types of enclosures that can be locked and unlocked using an electronic device via a wireless signal.

The detailed examples set forth below in connection with the appended drawings is intended to provide a description of various exemplary embodiments of the concepts disclosed herein and is not intended to represent the only embodiments in which the disclosure may be practiced. The detailed description includes specific details for the purpose of providing a thorough and complete disclosure that fully conveys the scope of the concepts to those skilled in the art. However, the disclosure may be practiced without these specific details. In some instances, well-known structures and components may be shown in block diagram or simplified form, or omitted entirely, to avoid obscuring the various concepts presented throughout this disclosure.

### 1. Terminology

Reference throughout this specification to one aspect, an aspect, one example or an example means that a particular feature, structure or characteristic described in connection with the embodiment or example may be a feature included in at least example of the present invention. Thus, appearances of the phrases in one aspect, in an aspect, one example or an example in various places throughout this specification are not necessarily all referring to the same example. Furthermore, the particular features, structures or characteristics may be combined in any suitable combinations and/or sub combinations in one or more embodiments or examples.

The term exemplary used in this disclosure means serving as an example, instance, or illustration, and should not necessarily be construed as preferred or advantageous over other embodiments presented in this disclosure.

Throughout the disclosure, the terms substantially or approximately may be used as a modifier for a geometric relationship between elements or for the shape of an element or component. While the terms substantially or approximately are not limited to a specific variation and may cover any variation that is understood by one of ordinary skill in the art to be an acceptable level of variation, some examples are provided as follows. In one example, the term substantially or approximately may include a variation of less than 10% of the dimension of the object or component. In another example, the term substantially or approximately may include a variation of less than 5% of the object or component. If the term substantially or approximately is used to define the angular relationship of one element to another element, one non-limiting example of the term substantially or approximately may include a variation of 5 degrees or less. These examples are not intended to be limiting and may be increased or decreased based on the understanding of acceptable limits to one of skill in the relevant art.

For purposes of the disclosure, directional terms are expressed generally with relation to a standard frame of reference when the aspects or articles described herein are in an in-use orientation. In some examples, the directional terms are expressed generally with relation to a left-hand coordinate system.

Terms such as a, an, and the, are not intended to refer to only a singular entity, but also include the general class of which a specific example may be used for illustration. The terms a, an, and the, may be used interchangeably with the term at least one. The phrases at least one of and comprises at least one of followed by a list refers to any one of the items in the list and any combination of two or more items in the list. All numerical ranges are inclusive of their endpoints and non-integer values between the endpoints unless otherwise stated.

The terms first, second, third, and fourth, among other numeric values, may be used in this disclosure. It will be understood that, unless otherwise noted, those terms are used in their relative sense only. In particular, certain components may be present in interchangeable and/or identical multiples (e.g., pairs). For these components, the designation of first, second, third, and/or fourth may be applied to the components merely as a matter of convenience in the description.

### II. Detailed Examples

As a non-limiting overview, aspects of the disclosure relate to a locking system, method, and/or kit usable for locking any type of enclosure that has a door or gate. One of many advantages of the locking system, method, and/or kit described herein is that the features described allow for a locking system to be easily mounted or adapted to function with a wide variety of doors or gates. Further, a locking system including any one or combination of the features described herein may be easy to operate and may operate even if misaligned during installation and/or use. Further, the aspects described herein allow for the locking system to be installed both on swinging or pivoting type doors or gates and/or sliding type doors or gates. In addition to these advantages, additional advantages will be become apparent based on the description of the detailed examples below.

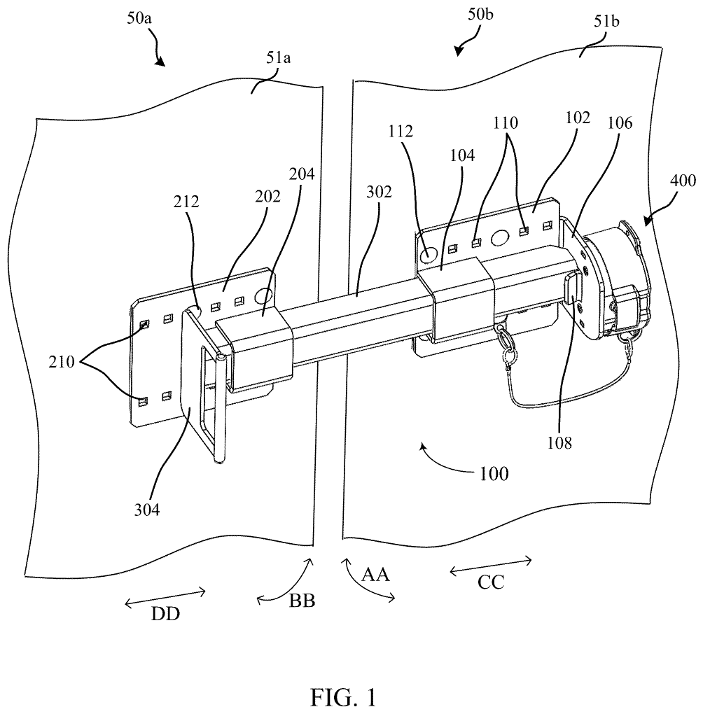

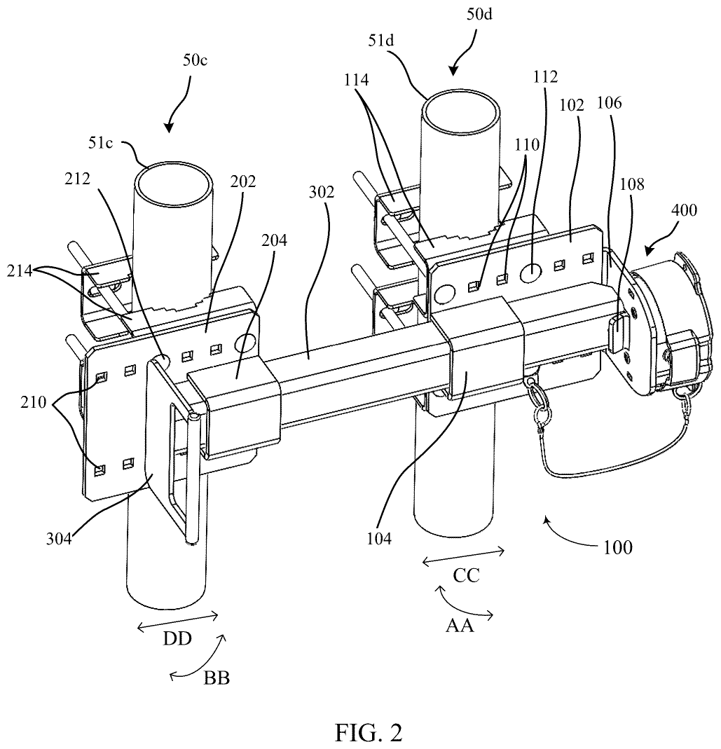

As noted above, one of the advantages of the aspects described herein is that a locking system 100 may be adaptable or otherwise retrofittable to various types of doors and/or gates. For example, FIG. 1 shows a locking system 100 according to aspects of the disclosure mounted to a first example of a type of enclosure. The enclosure may include a first door 50a and a second door 50b. In some aspects of the disclosure, the first door 50a and/or the second door 50b may be gates or doors, at least one of which is configured to swing open/closed in directions AA and/or BB. In another example, at least one of the first door 50a and/or the second door 50b may be configured to slide open/closed in directions DD and/or CC. As shown in FIG. 1, the first type of enclosure may have a surface or surfaces 51a and 51b for mounting the locking system 100 thereto. For example, a first surface 51a may be associated with a first door 50a and the second surface 51b may be associated with a second door 50b. In another example, a locking system 100 may be connectable to a second example of a type of enclosure as shown in FIG. 2. In the example of FIG. 2, locking system 100 may be mountable to first pole or tube 51c of a first gate or door 50c and may be mountable to a second pole or tube 51d of a second gate or door 50d. The example shown in FIG. 2 may for example represent a gate or sliding opening for enclosure fencing such as a gate with chain link fencing.

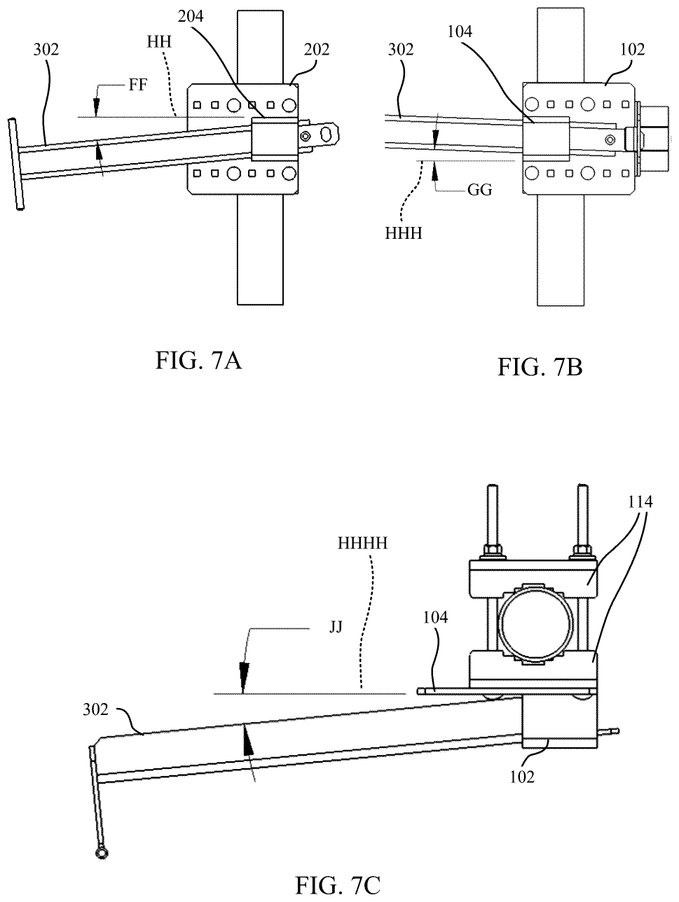

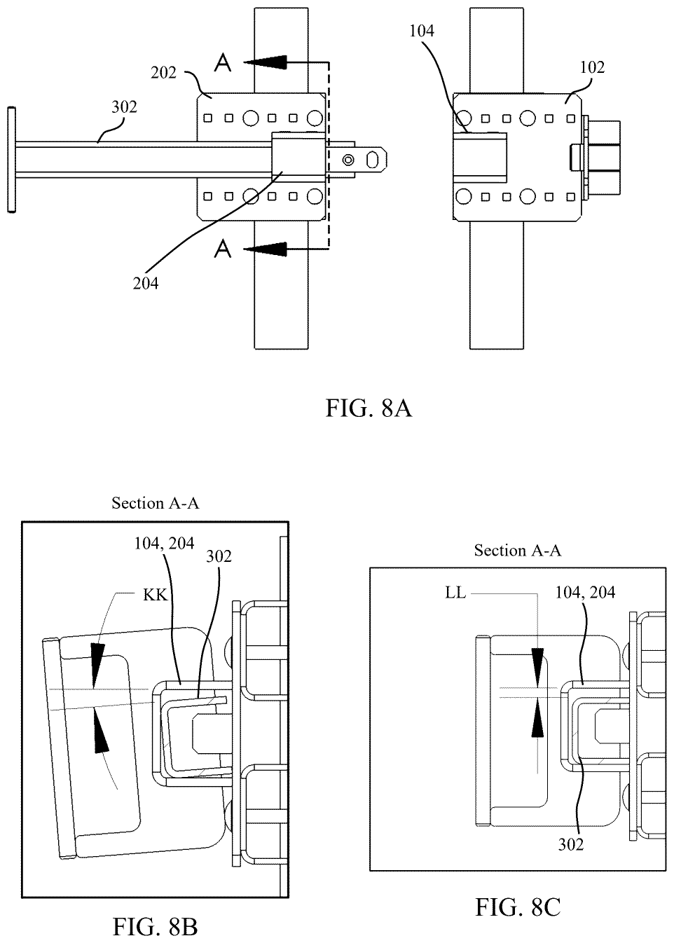

Referring to FIGS. 1-3, the locking system 100 may include a first mounting bracket 102 and a second mounting bracket 202 to connect the components of the locking system 100 to opposing portions of the enclosure to be secured. The first mounting bracket 102 may include a locking bar retainer 104 for receiving and slideably retaining a locking bar 302. The locking bar 302 may be configured to slide into the locking bar retainer 104. In some examples, the locking bar retainer 104 may be dimensioned so as to retain the locking bar 302 while still allowing the locking bar 302 to slide into and slide within the locking bar retainer 104 to lock or otherwise prevent movement of the first door 50a, 50c, and/or the second door 50b, 50d from moving in either one of the opening/closing directions mentioned above. In some examples, the locking bar retainer 104 may have inner dimensions that are slightly larger than the outer dimensions of the locking bar 302, which in addition to allowing the sliding action, additionally allows an amount of misalignment while still enabling the locking system 100 to be locked and unlocked. For example, the locking bar retainer 104 may have inner dimensions that are between 1-15% larger than the locking bar 302 outer dimensions. In another example, the locking bar retainer 104 may have inner dimensions that are between 2-8% larger than the locking bar 302 outer dimensions. Additional aspects of the dimensional differences between the locking bar retainer 104 and the locking bar 302 are described below with respect to Figures. 7A-8C.

The second mounting bracket 202 may include a second locking bar retainer 204 for slideably retaining the locking bar 302. The locking bar 302 may be configured to slide within the second locking bar retainer 204. In some examples, the second locking bar retainer 204 may have inner dimensions that are slightly larger than the outer dimensions of the locking bar 302, which in addition to allowing the sliding action, additionally allows an amount of misalignment while still enabling the locking system 100 to be locked and unlocked. The second locking bar retainer 204 may have inner dimensions that are between 1-15% larger than the locking bar 302 outer dimensions. In another example, the second locking bar retainer 204 may have inner dimensions that are between 2-8% larger than the locking bar outer dimensions. Additional aspects of the dimensional differences between the second locking bar retainer 204 and the locking bar 302 are described below with respect to FIGS. 7A-8C. It should be noted that the inner dimensions of the second locking bar retainer 204 and the (first) locking bar retainer 104 may cooperatively enable misalignment between adjacent enclosure components.

Both the first mounting bracket 102 and the second mounting bracket 202 may include a series of mounting features 110 and/or 210. The mounting features may, for example, be one or more mounting holes or openings as shown in FIGS. 1-4A. It is noted that while only two of the mounting features 110 on first mounting bracket 102 and two of the mounting features 210 on the second mounting bracket 202 are indicated by reference numbers, any number of mounting features may be provided on each of the first mounting bracket 102 and the second mounting bracket 202. In the example shown in FIGS. 1-5A, 7A, 7B, and 8A, twelve (12) mounting holes or openings are provided on the first mounting bracket 102 and the second mounting bracket 202 to allow for flexibility in mounting the first mounting bracket 102 and/or the second mounting bracket 202 to various types of doors or gates. As an alternative example, the first mounting bracket 102 and/or the second mounting bracket 202 may have anywhere from two (2) to thirty (30) mounting points or openings. In one example, the openings may be square-shaped or otherwise shaped to retain a portion of a fastener. For example, the openings may be square shaped as shown in FIGS. 1-5A, 7A, 7B, and 8A to retain a square shaped retaining feature of one or more carriage bolts (e.g., fasteners 212 in FIGS. 1, 2, and 3).

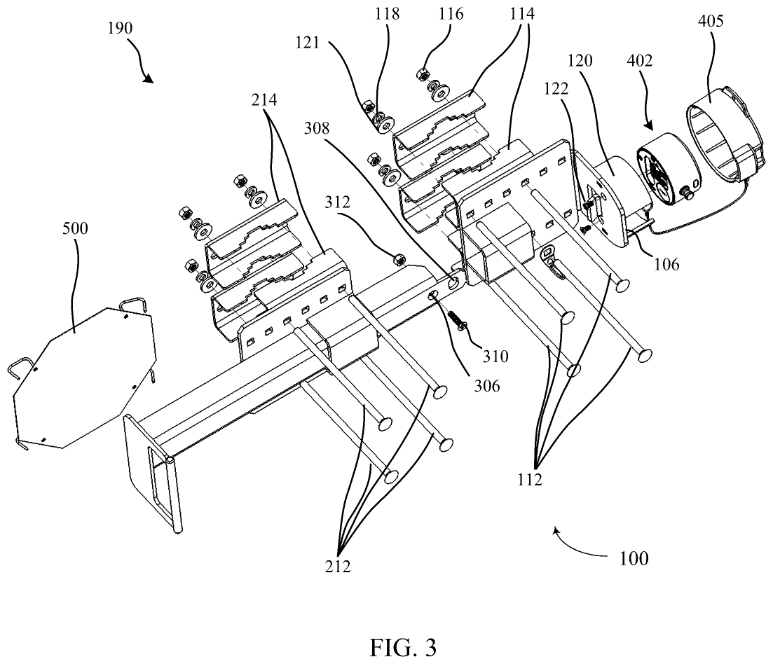

Turning to FIG. 1, the first mounting bracket 102 and/or the second mounting bracket 202 may be surface mounted and/or the first mounting bracket 102 and/or the second mounting bracket 202 may be mounted to tubing 51c and/or 50d as shown in FIG. 2. It is noted that while round tubing is shown in FIG. 2, the locking system 100 according to aspects of this disclosure may be mounted to tubing with any cross-sectional shape (e.g., square, rectangular, triangular, octagonal). When the locking system 100 is mounted to tubing, a first clamp bracket 114 and/or a second clamp bracket 214 may be implemented. The first clamp bracket 114 and/or the second clamp bracket 214 may have a toothed or stepped clamping region for contacting and gripping tubing when the fasteners 112 and/or 212 are passed through the mounting features 110 and/or 210 and passed through slotted holes in each of the first clamp brackets 114 and/or the second clamp bracket 214. A series of nuts (e.g. nut 116 labeled in FIG. 3) and/or a series of washers (e.g., washer 121) and/or series of lock-washers (e.g., lock washer 118) may then be installed. Tightening the series of nuts onto the fasteners 112 and 212 may then cause the tube (e.g., tubes 51c and 51b in FIG. 2) to be clamped between the first clamp brackets 114 and second clamp brackets 214 to fasten the respective first mounting bracket 102 and/or the second mounting bracket 202 to a tubes 51c and/or 51d.

In one example implementation of the disclosure, once the first mounting bracket 102 and/or the second mounting bracket 202 are mounted to respective doors and/or gates as described above. The locking bar 302 can be slid through the second locking bar retainer 204 and the locking bar retainer 104 prevent either one of or both of the first door or gate 50a and/or 50c and/or the second door or gate 50b and 50d from moving with respect to one another (e.g., by restriction motion of any of the above doors or gates in any one or combination of directions AA, BB, CC and/or DD).

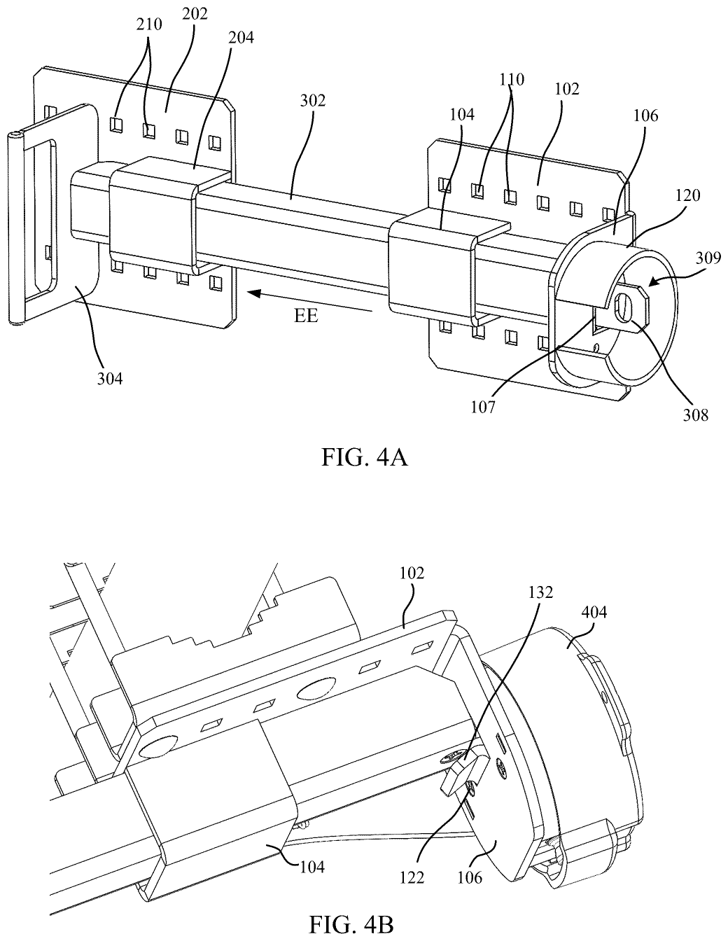

To secure the locking bar 302 with respect to the first mounting bracket 102 and second mounting bracket 202, and to prevent unauthorized removal of the locking bar 302 (and thus opening of the door or gate the locking system 100 is intended to secure), a lock system 400 may be implemented. The lock system 400 may lock a hasp portion 309 (FIG. 4A) of the locking bar 302 and prevent the locking bar 302 from being slid or removed in direction EE by locking the location of the hasp 309 with respect to a lock mounting portion 106 of the first mounting bracket 102.

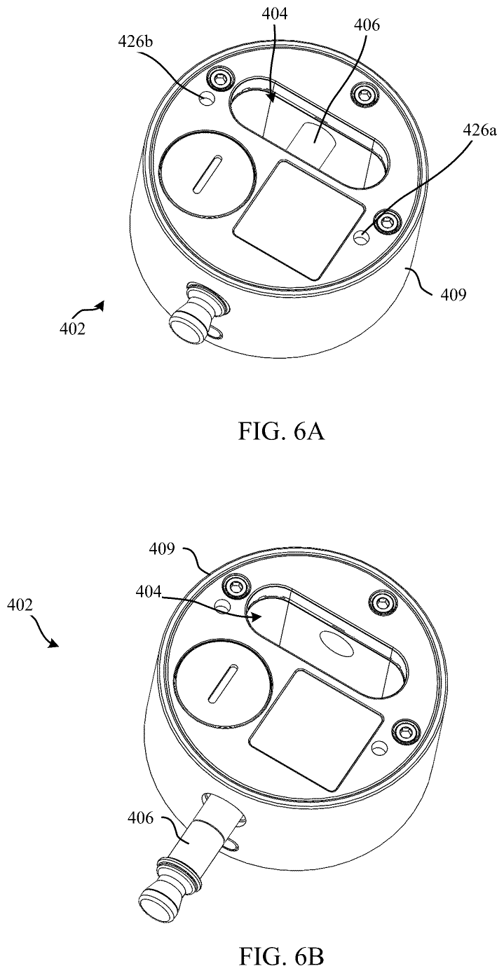

In one example implementation of the disclosure, the hasp 309 (FIG. 4A) may include a hasp locking feature 308. In the example implementation shown in FIG. 4A, the hasp locking feature 308 is an opening configured to have a lock bolt passed therethrough. One example of a lock bolt 406 is described below with respect to FIGS. 6A and 6B.

The lock mounting portion 106 may include a lock mount opening configured to receive and have passed therethrough at least a portion of the hasp 309 and the hasp locking feature 308. With the aforementioned configuration, once hasp locking feature 308 is slid through the lock mount opening 107 and a lock bolt is passed through the hasp locking feature 308, the hasp 309 is locked with respect to the first mounting bracket 102, which prevents the locking bar 302 from being slid in direction EE and further prevents the locking bar 302 from being slid out of the locking bar retainer 104. Thus, once the locking bar 302 is slid through the locking bar retainer 104 and the hasp is slid through the lock mount opening 107 and a lock bolt passed through the hasp locking feature 308, the door or gates that the locking system 100 is mounted to can secured in a closed configuration. Conversely, if the lock bolt is removed from the hasp locking feature 308 of the hasp 309, the locking bar 302 can be slid in direction EE until the locking bar 302 is no longer constrained within the locking bar retainer 104, and the door or gates that the locking system 100 is mounted to can be opened.

In one aspect of the disclosure, the lock mounting portion 106 may include a hasp guide portion 132 (FIG. 4B). The hasp guide portion 132 may be ramped or otherwise angled or tapered to help guide the hasp 309 of the locking bar 302 through the lock mount opening 107. The hasp guide portion 132 may further improve usability of the locking system 100 by improving case of locking of the gates or doors with the locking system 100 by preventing the hasp 309 from missing lock mount opening 107 when the locking bar 302 is slid through the locking bar retainer 104. Further, the hasp guide portion 132 may further improve compatibility over a wide-range of gate and door configurations by compensating for tolerances or differences in different types and configurations of doors and/or gates (e.g., by guiding the hasp 309 into the lock mount opening 107 even if the hasp 309 is misaligned with respect to the lock mount opening 107).

The locking bar 302 may further include a handle 304 at an end thereof to improve ergonomics and provide a user with an easy to grip handle connected to locking bar 302 to allow a user to slide the locking bar 302 easily, even if wearing gloves or if the handle is wet for example.

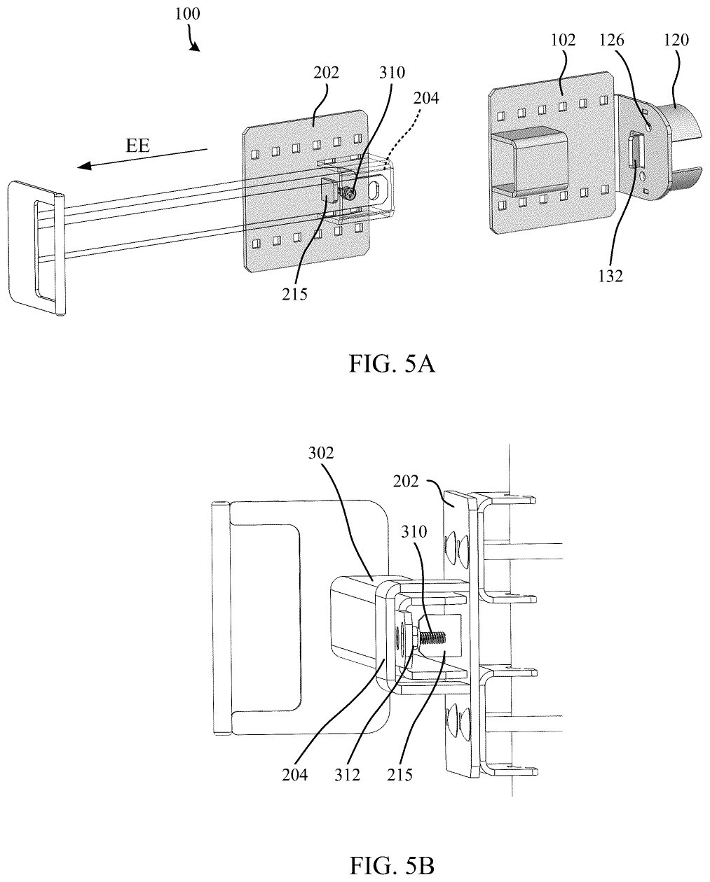

The locking system 100 may further include a slide stop mechanism for locking bar 302. The slide stop mechanism may prevent the locking bar 302 from being completely removed from or slid out of the second locking bar retainer 204. Thus, a slide stop mechanism may prevent locking bar 302 from being slide in direction EE (FIG. 5A) past second locking bar retainer 204, which may prevent the locking bar 302 from falling or from being unintentionally removed or separated from the second mounting bracket 202. As best shown in FIGS. 3, 5A, and 5B, the slide stop mechanism may include a bolt 310 or other projection or protrusion that interferes with or otherwise contacts a corresponding tab 215 or other projection or protrusion of the second mounting bracket 202. In the example shown in FIGS. 3, 5A, and 5B, the bolt 310 may be passed through or threaded through a corresponding opening in the locking bar 302 and a nut 312 may be installed to fix the bolt 310 with respect to the locking bar 302. As shown in FIGS. 5A and 5B, once the locking bar 302 is slid in direction EE past a certain point, the bolt 310 hits the corresponding tab 215 of the second mounting bracket 202, preventing the locking bar 302 from being pulled out of the second locking bar retainer 204.

FIGS. 6A and 6B show example lock 402 that may be usable as part of or as the entire lock system 400 mentioned above with respect to FIGS. 1 and 2. The lock may for example be circular and include a lock body 409 and a removable and/or slideable bolt 406. FIG. 6A shows one example of the lock 402 in a locked configuration and FIG. 6B shows one example of the lock 402 in an unlocked configuration. The lock 402 may further include a lock opening 404. The lock opening may be configured to receive all of or part of a hasp (e.g., hasp 309 in FIG. 4B). Once the hasp 309 is within the lock opening 404, the lock bolt 406 can be moved from the unlocked position (e.g., as shown in FIG. 6B) to the locked position (e.g., as shown in FIG. 6A with the lock bolt 406 passing through the hasp locking feature 308 (FIG. 4A) to prevent separation of the locking bar 302 from the locking bar retainer 104. Conversely, when the lock 402 is unlocked (e.g., as shown in FIG. 6B) and the bolt is pulled out of the lock opening 404 the locking bar 302 can again be separated from the locking bar retainer 104 of the first mounting bracket 102.

One example of a lock usable with the disclosure is known as a puck lock. In one example implementation of the disclosure, the lock 402 may be a wireless or keyless lock that is electronically controlled. Some examples of keyless or wireless locks usable with aspects of the disclosure are described U.S. patent application Ser. No. 17/590,527 filed on Feb. 1, 2022, entitled “KEYLESS PUCK LOCK APPARATUS AND SYSTEM,” U.S. patent application Ser. No. 17/232,124 filed on Apr. 15, 2021, entitled “KEYLESS PUCK LOCK APPARATUS AND SYSTEM,” U.S. patent application Ser. No. 16/806,553 filed on Mar. 2, 2020, entitled “KEYLESS PUCK LOCK APPARATUS AND SYSTEM,” U.S. patent application Ser. No. 16/103,554 filed on Aug. 14, 2018, entitled “KEYLESS PUCK LOCK APPARATUS AND SYSTEM,” and U.S. patent application Ser. No. 13/414,348 filed on Mar. 7, 2012, now U.S. Pat. No. 10,089,811, entitled “LOCK.” Each of the aforementioned applications are hereby incorporated by reference in their entireties. Further, it is noted that a manual lock may be implemented with or used with aspects of the disclosure. For example, the lock 402 may be a lock requiring a key and/or a combination for unlocking the lock. As shown in FIG. 3, the locking system 100 may include a sign or placard 500 that provides information for unlocking the lock 402 (e.g., a webpage, a quick-response (QR) code, a phone number, and/or instructions or symbolic instructions).

As shown in FIGS. 1-3 and 4B, the lock 402 may be installable to the locking system 100 so that the lock 402 remains with a portion of the locking system 100 even if in the unlocked configuration. Installing the lock 402 to the locking system may prevent the lock 402 from being lost and/or dropped when the lock is in the unlocked configuration. In some examples, the lock 402 may have mounting points 426a and 426b (FIGS. 6A and 6B). The mounting points 426a and/or 426b may be threaded holes configured to threadably engage with a threaded fastener. As best show in FIGS. 1-3, 4B, and 5A, the lock 402 may be installable to the lock mounting portion 106 of the 102. For example, the lock mounting portion 106 may have one or more through holes or openings 126 (FIG. 5A) that align with the mounting points 426a and/or 426b, allowing fasteners 122 (FIG. 3) to be installed through the holes or openings 126 and threadably engaged with the mounting points 426a and/or 426b of the lock 402. Once the one or more fasteners are installed through the holes or openings 126 and tightened into mounting points 426a and/or 426b, the lock 402 is installed to lock mounting portion 106 with the lock opening 404 being aligned with the lock mount opening 107 (FIG. 4A) so that the hasp or part of the hasp can be slid through the lock mount opening 107 and into the lock opening 404 for locking the locking bar 302 with respect to the first mounting bracket 102.

The first mounting bracket 102 may additionally include a lock guard 120 as part of the lock mounting portion 106. The lock guard 120 may be a protrusion that corresponds with the outside dimensions of the lock to protect the lock and/or to prevent tampering with the lock. For example, as shown in FIGS. 3, 4A, and 5A the lock guard 120 may be a circular or semi-circular protrusion or wall-shaped portion that surrounds the lock body 409 when the lock 402 is installed to the first mounting bracket 102. Further, the locking system 100 may include a removable cover lock opening 404 for protecting the lock 402 from the elements and/or from tampering or other damage. As shown in FIG. 2 a tether may connect the cover to the first mounting bracket 102 to prevent the cover from being lost or removed.

As noted above, one advantage of the locking system 100 described herein is that the locking system may improve case of use and installation and compatibility with multiple types of doors and gates. For example, sometimes a gate may be temporary during construction and thus the gate is quickly built since the gate may eventually be removed. Since the gate may be quickly built and built as economically as possible, the gate may be misaligned, out of plumb, uneven, and/or may move, sag, or otherwise shift during use. Aspects of this disclosure provide advantages in case of installing the locking system 100 and allowing for the use of the locking system 100 even if the first mounting bracket 102 and the second mounting bracket 202 are not optimally aligned. FIGS. 7A-8C show examples the improved compatibility and usability of a locking system 100 according to aspects of this disclosure even if the gates or doors that the locking system 100 is mounted to are not necessarily properly aligned.

FIGS. 7A and 7B are side views showing examples of misalignment features of the locking system 100 according to aspects of the disclosure. In one example, the locking bar 302 may still properly function and slide within the second locking bar retainer 204 when locking bar 302 is angled relative to the second locking bar retainer 204 and/or second mounting bracket 202. In one example, the second locking bar retainer 204 and the locking bar 302 may be dimensioned (e.g., the inner dimensions of second locking bar retainer 204 may be larger than the outer dimension of the locking bar 302) to allow the locking bar 302 to be angled FF with respect to a horizontal line HH or line parallel with a central axis of the second mounting bracket 202. In one example, angle FF may be 3-10 degrees. In another example, angle FF may be 5-9 degrees. In another example, the angle FF may be approximately 7 degrees.

As shown in FIG. 7B, the locking bar 302 may also still properly function and slide within the locking bar retainer 104 when locking bar 302 is angled relative to the locking bar retainer 104 and/or first mounting bracket 102. In one example, the locking bar retainer 104 and the locking bar 302 may be dimensioned (e.g., the inner dimensions of locking bar retainer 104 may be larger than the outer dimension of the locking bar 302) to allow the locking bar 302 to be angled GG with respect to a horizontal line HHH or line parallel with a central axis of the first mounting bracket 102. In one example, angle GG may be 1-7 degrees. In another example, angle GG may be 2-5 degrees. In another example, the angle GG may be approximately 3 degrees.

FIG. 7C shows an example top-down view of a portion of locking system 100 to show additional examples of misalignment features of the locking system 100. As shown in FIG. 7C, the locking bar 302 may also still properly function and slide within the locking bar retainer 104 when locking bar 302 is angled relative to the locking bar retainer 104 and/or first mounting bracket 102. In one example, the locking bar retainer 104 and the locking bar 302 may be dimensioned (e.g., the inner dimensions of locking bar retainer 104 may be larger than the outer dimension of the locking bar 302) to allow the locking bar 302 to be angled JJ with respect to a line or axis HHHH or line parallel with a central axis of the first mounting bracket 102. In one example, angle JJ may be 2-10 degrees. In another example, angle JJ may be 4-8 degrees. In another example, the angle JJ may be approximately 5 degrees.

FIGS. 8A, 8B, and 8C show a side view and partial views about section A-A in FIG. 8A of a locking system 100 to show additional examples of misalignment features according to aspects of the disclosure. As shown in FIG. 8B, the locking bar 302 may also still properly function and slide within either one of or both of the locking bar retainer 104 and the second locking bar retainer 204 when locking bar 302 is rotated or angled relative to the locking bar retainer 104 and/or second locking bar retainer 204. In one example, the locking bar retainer 104 and/or the second locking bar retainer 204 and the locking bar 302 may be dimensioned (e.g., the inner dimensions of locking bar retainer 104 and/or second locking bar retainer 204 may be larger than the outer dimension of the locking bar 302) to allow the locking bar 302 to be angled or rotated KK with respect to a horizontal axis or line perpendicular to the central axis of the first mounting bracket 102 and/or the second mounting bracket 204. In one example, angle KK may be 2-10 degrees. In another example, angle KK may be 4-8 degrees. In another example, the angle KK may be approximately 5 degrees.

As shown in FIG. 8C, the locking bar 302 may also still properly function and slide within either one of or both of the locking bar retainer 104 and the second locking bar retainer 204 when locking bar 302 is shifted relative to the center of the locking bar retainer 104 and/or second locking bar retainer 204. In one example, the locking bar retainer 104 and/or the second locking bar retainer 204 and the locking bar 302 may be dimensioned (e.g., the inner dimensions of locking bar retainer 104 and/or second locking bar retainer 204 may be larger than the outer dimension of the locking bar 302) to allow the locking bar 302 to be shifted a distance LL with respect to a center of the first mounting bracket 102 and/or the second mounting bracket 204. In one example, KK may be 1/16-1 inches. In another example, a shift distance KK may be ⅛-¾ inches. In another example, the shift distance may be approximately ¼ inches.

In addition to the advantages described herein, the features described above may allow the locking system 100 to be compatible with various types of doors, gates, and openings, and may allow the locking system 100 to be installed quickly and easily while still allowing for case of operation.

The present disclosure is provided to enable any person skilled in the art to practice the various aspects described herein. Various modifications to these example embodiments presented throughout the present disclosure will be readily apparent to those skilled in the art, and the concepts disclosed herein may be applied to other techniques for printing nodes and interconnects. Thus, the claims are not intended to be limited to the example embodiments presented throughout the disclosure, but are to be accorded the full scope consistent with the language claims. All structural and functional equivalents to the elements of the example embodiments described throughout the present disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. A lock system, comprising:
a first mounting bracket for mounting to a first door or gate;
a second mounting bracket for mounting to a second door or gate; and
a locking bar with a hasp and a hasp opening configured to be slideably received by a locking bar retainer of the first mounting bracket and a second locking bar retainer of the second mounting bracket,
wherein the locking bar is configured to be slid through the locking bar retainer and into the second locking bar retainer until a hasp of the locking bar passes through a lock mount opening of a lock mounting portion of the first mounting bracket, and wherein the hasp opening is configured to have a lock bolt passed therethrough to lock the position of the locking bar with respect to the first mounting bracket.

2. The lock system of claim 1, wherein the hasp is configured to be guided into the lock mount opening via an angled hasp guide portion.

3. The lock system of claim 1, wherein a lock is configured to be mounted to the lock mounting portion of the first mounting bracket.

4. The lock system of claim 3, wherein the lock mounting portion is configured to have the lock mounted thereto via one or more threaded fasteners passed through openings in the lock mounting portion.

5. The lock system of claim 1 further comprising a slide stop mechanism, wherein the slide stop mechanism prevents the locking bar from being slid out of the second locking bar retainer of the second mounting bracket.

6. The lock system of claim 1, further comprising a plurality of clamp brackets for mounting at least one of the first mounting bracket or the second mounting bracket to a tube.

7. The lock system of claim 1, wherein the lock mounting portion further comprises a curved lock guard for covering at least a portion of a lock mounted to the lock mounting portion.

8. A door latch usable with a lock, comprising:
a first mounting bracket for mounting to a first door or gate;
a second mounting bracket for mounting to a second door or gate;
a locking bar with a hasp and a hasp opening configured to be slideably received by a locking bar retainer of the first mounting bracket and a second locking bar retainer of the second mounting bracket,
wherein the locking bar is configured to be slid through the locking bar retainer and into the second locking bar retainer until a hasp of the locking bar passes through a lock mount opening of a lock mounting portion of the first mounting bracket, and wherein the hasp opening is configured to have a lock bolt passed therethrough to lock the position of the locking bar with respect to the first mounting bracket and wherein a lock is configured to be mounted to the lock mounting portion of the first mounting bracket.

9. The door latch of claim 8, wherein the hasp is configured to be guided into the lock mount opening via an angled hasp guide portion.

10. The door latch of claim 8, wherein the lock mounting portion is configured to have the lock mounted thereto via one or more threaded fasteners passed through openings in the lock mounting portion.

11. The door latch of claim 8, further comprising a slide stop mechanism, wherein the slide stop mechanism prevents the locking bar from being slid out of the second locking bar retainer of the second mounting bracket.

12. The door latch of claim 8, further comprising a plurality of clamp brackets for mounting at least one of the first mounting bracket or the second mounting bracket to a tube.

13. The door latch of claim 8, wherein the lock mounting portion further comprises a curved lock guard for covering at least a portion of a lock mounted to the lock mounting portion.
